(19) United States
(12) Patent Application Publication
(10) Pub. No.: US 2025/0023295 A1
(43) Pub. Date: Jan. 16, 2025

(54) Connector with contact insert attachment

(71) Applicant: HARTING Electric Stiftung & Co. KG, Espelkamp (DE)

(72) Inventor: Sebastian GRIEPENSTROH, Lübbecke (DE)

(73) Assignee: HARTING Electric Stiftung & Co. KG, Espelkamp (DE)

(21) Appl. No.: 18/769,419

(22) Filed: Jul. 11, 2024

(30) Foreign Application Priority Data
Jul. 13, 2023 (DE) 10 2023 118 586.1

(51) Int. Cl. H01R 13/639; H01R 13/518; H01R 13/627

(52) U.S. Cl. CPC H01R 13/639; H01R 13/518; H01R 13/627

(57) ABSTRACT

The invention is based on an electrical connector, having a connector housing with a cable feedthrough opening, a connection opening, at least one first retention feature and at least one contact insert. The contact insert accommodates at least one contact element and/or at least one connector module and/or a half connector module and has at least one fastening frame. The fastening frame has at least one second retention feature, wherein the second retention feature corresponds to the first retention feature, and wherein at least one fastener interacts with the first retention feature and the corresponding second retention feature.

### CROSS-REFERENCE TO RELATED APPLICATION

This application claims the benefit of German Patent Application DE 10 2023 118 586.1, filed on Jul. 13, 2023, the content of which is incorporated by reference in its entirety.

### BACKGROUND

The present application relates to an electrical plug-in connector with a contact insert attachment. The application further relates to a method for connecting a contact insert to a connector housing of a connector.

Contact insert attachments are required to fasten a contact insert, which may for example be designed as a module holding frame for accommodating connector modules and/or half connector modules, in a connector housing, preferably detachably.

Industrial connectors, also known as heavy-duty connectors or rectangular connectors, usually have a contact insert which is releasably attached to the connector housing by means of screw connections. The contact insert can be designed to directly receive contact elements. Alternatively, the state of the art also offers solutions in which a contact insert is designed as a holding frame, which in turn accommodates one or more identical and/or different connector modules. Connector modules can consist of several modular components, which can be of the same or different design.

U.S. Pat. No. 6,004,162 discloses a connector with a contact carrier, wherein the contact carrier is designed as a holding frame for connector modules. The contact carrier is usually fastened in the connector housing using screw connections. U.S. Pat. No. 6,004,162 is incorporated by reference in its entirety.

A disadvantage of the connection technology primarily used in the prior art is the comparatively long time required to detachably insert a contact carrier into a connector housing by means of the usually four screw connections provided at the corners of the contact carrier.

### SUMMARY

The present disclosure provides a connector which can be equipped with a contact insert in a simple and quick manner. The contact insert is detachably and firmly fastened in a connector housing of the connector.

Furthermore, the disclosure provides a method for the simple and rapid fastening of a contact insert in a connector housing, which method engages the contact insert detachably and with a firm fit in the connector housing.

An electrical connector has a connector housing with a cable feedthrough opening, a connection opening, at least one first retention feature and at least one contact insert. The contact insert accommodates at least one contact element and/or at least one connector module and/or a half connector module and has at least one fastening frame. The fastening frame has at least one second retention feature. The second retention feature corresponds to the first retention feature. In particular, the second retention feature is coaxially aligned with the first retention feature. At least one fastener interacts with the first retention feature and the corresponding second retention feature. As a result, the fastening frame is held in the connector housing with the help of the fastener. The fastener has at least one fastener body, a fixing element, and a locking element.

Connector housings are generally understood to be housings of cable ends provided with contact elements. Connector housings are usually made of metal or plastic. In the case of a plastic housing, electrically conductive plastics are also used. There are also connector housings that are formed from composite materials, wherein the housings can be formed from metal and plastic or various metals or various plastics.

Cable feedthrough openings are particularly apertures in the connector housing through which one or more electrical wires and/or cables can pass through into the connector. These cable feedthrough openings are usually sealed by cable glands so that the cables passed through the openings are at least partially sealed against foreign media such as dust, dirt, or fluids.

The term connection opening refers to an aperture in the connector housing which is designed for connection to a mating connector, or the mating connector housing and/or the contact elements arranged therein.

The term first retention feature refers to a device on or within the connector housing which is designed to enable the attachment of further components of the connector. Usually, blind holes with internal threads are used in connector housings, into which a screw is inserted to attach additional components. The first retention feature usually protrudes into the connector housing, whereby further components are secured towards the interior of the connector housing. The first retention feature may in particular be a blind hole, a cavity, a slot or an indentation, generally forming a hollow receptacle.

The term contact insert encompasses various designs. For example, contact inserts can be simple insulating bodies and/or contact carriers which are used to accommodate and/or spatially and/or electrically separate contact elements. Populated module holding frames, i.e. holding frames with modules accommodated therein, are also understood as contact inserts. Such module holding frames are designed to accommodate different and/or similar connector modules, whereby each connector module is understood as a contact insert or contact carrier. Recently, there have also been a large number of connector modules which can be formed from identical and/or different sub-modules.

On the one hand, fastening frames are molded and/or mounted frames which are designed to fasten a contact insert in a connector housing. A module holding frame also usually has the characteristics of a fastening frame. Particularly in the case of simple insulating bodies, fastening frames can be designed in several parts and arranged on the insulating body. Fastening frames are often made of two individual elements, which are arranged on the narrow sides of the contact inserts, in particular in industrial connectors, and do not have a direct connection to one another.

The term second retention feature refers to a device on or within the fastening frame which is designed to enable the attachment of a contact carrier to the connector housing. Typically, through holes are used in fastening frames through which a screw is passed for fastening to the connector housing. The second retention feature usually protrudes outwards, i.e. away from the contact carrier. The second retention feature may be an aperture, for example a through hole.

The fastener refers to an element which is provided for connecting the first retention feature to the second retention feature. The fastener is used to secure a contact insert in a connector housing. Ideally, the fastener is designed to releasably connect the contact insert to the connector housing. The fastener is composed of various components. These components include at least one fastener body, one fixing element, and one locking element. For different embodiments, the named components can consist of several elements. It may therefore make sense for the fastener body to comprise at least two elements, for example a socket and a fastening feature arranged thereon for connection to the first retention feature. In a particularly advantageous manner, the fixing element can be provided with a securing element in order to be secured against loss in a corresponding securing feature in the fastener body.

The fastener may be a locking clip or a plastic rivet. The locking clip or plastic rivet includes a shank (cylindrical fastener body) and a mandrel (fixing element, pin). A circumferential bulge (locking element) extends around the shank.

The fastener designed in this way enables simple, quick and reliable installation of the contact insert in the connector housing. It is particularly useful to design the fixing element as a pin-like element with a head and/or flange, which makes it possible, on the one hand, to not insert the inserted fixing element too far into the fastener body and, on the other hand, to remove the fixing element from the fastener body again. This ensures that the simple installation of the contact insert can be reversed just as easily.

In one embodiment, the fastener body is connected to the first retention feature. This means that at least a part of the fastener body, which is directed against the plug-in direction, is screwed, pressed or glued into a first retention feature.

In a further embodiment, the locking element is connected to the second retention feature. A locking sleeve, a locking spring, a locking hook or a comparable element can be used as a locking element. According to the invention, the locking element engages behind the second retention feature in the plug-in direction and thus fixes the contact insert in the connector housing.

A clever embodiment provides that the locking element is essentially formed as a circumferential bulge, which has a larger outer diameter than an inner diameter of the second retention feature. Alternatively, the locking element is designed as at least one locking hook arranged on the fastener body, which holds the second retention feature in the connected state in the connector housing.

In a further developed embodiment, the contact insert with its fastening frame and the second retention feature arranged thereon is pushed over the locking element of the fastener, wherein the locking element elastically deflects into the interior of the fastener body.

A further embodiment provides that the fixing element is inserted into the fastener body against the plugging direction.

In a clever embodiment, the connector housing accommodates at least a first fastener and at least a second fastener, wherein the first fastener is designed as a socket element and the second fastener is designed as a pin element.

A further developed embodiment provides that a fixing element is arranged on the second fastener, which fixing element is brought into engagement with the first fastener in a plugged-in state of the connector housing with a mating connector housing.

Furthermore, a method for connecting a contact insert to a connector housing is disclosed, wherein the connector housing has at least a first retention feature and wherein the contact insert has at least a second retention feature, wherein the first retention feature corresponds to the second retention feature and wherein at least one fastener is used to connect the contact insert to the connector housing, which fastener has a fastener body, a fixing element and a locking element.

A further embodiment of the method provides that the fastener body is designed essentially as a hollow pin which has elongated through openings and/or slots on which the locking element is arranged so as to be elastically displaceable inwards.

A clever embodiment of the method provides that the fixing element is introduced into the fastener body and blocks the elastic displacement of the locking element.

A further embodiment of the method provides that the connector accommodates at least a first fastener and a second fastener, wherein the second fastener has a fixing element, which in the plugged-in state of the connector housing with a mating connector housing interacts with the fastener body of the first fastener.

Finally, one embodiment of the method provides that the first fastener and second fastener are used as coding. This means that the fasteners are used as means for securing against incorrectly oriented plugging of the connector and the mating connector or accidental plugging of a first connector with a second mating connector meant for a second connector.

### BRIEF DESCRIPTION OF THE DRAWINGS

FIG. 1 is a perspective sectional view of a fastener in a connector;

FIG. 2 is a rotated perspective sectional view of a fastener in a connector;

FIG. 3 is a perspective sectional view of an alternative fastener in a connector;

FIG. 4 is a perspective view of a fastener in a fastening frame.

### DETAILED DESCRIPTION

The figures contain partially simplified, schematic illustrations. In some cases, identical reference numerals are used for alike, but possibly not identical elements. Different views of the same elements could be scaled differently. Directional indications such as “left,” “right,” “top,” and “bottom” are to be understood with reference to the respective figure and do not indicate any particular orientation of the connector when in use.

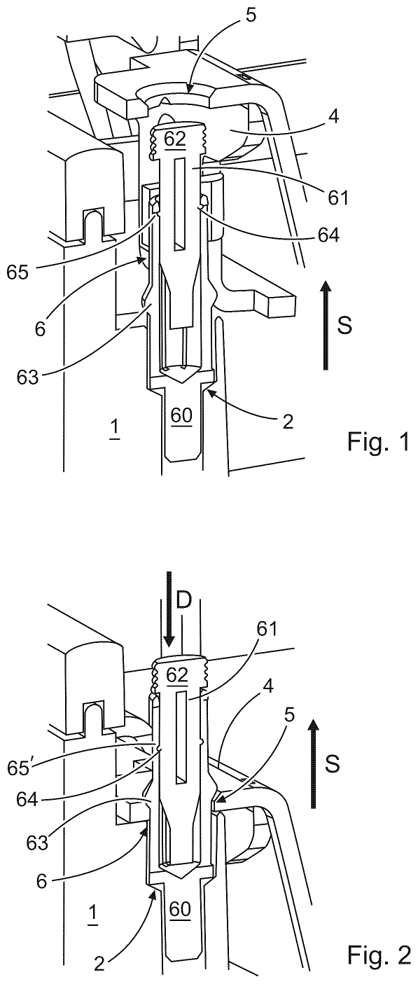

FIG. 1 and FIG. 2 show a section of a connector with a connector housing 1 and a first retention feature 2 located therein. Furthermore, a fastening frame 4 of a contact insert 3 can be seen, although the contact insert 3 is not shown. The fastening frame 4 has a second retention feature 5. The fastener 6 is connected to the first retention feature 2. The fastener 6 is essentially designed in two parts. First, the fastener body 60 of the fastener 6 can be seen connected to the first retention feature 2. The fastener body 60 is essentially hollow-cylindrical. A fixing element 61 is arranged in the fastener body 60. The fixing element 61 has a head which serves as a release element 62. The release element 62 enables, or at least simplifies, the release of the fastener 6 from the second retention feature 5. To prevent loss and to facilitate handling, the fixing element 61 has a securing element 64, which in the opened state engages in a first securing feature 65. The first securing feature 65 is located at an end region of the fastener body 60 in the plugging direction S. A second securing feature 65′ is arranged in the fastener body 60 such that the fixing element 61 is secured in a closed position. Provided circumferentially on the outside of the fastener body 60 is a bulge which functions as a locking element 63 and initially enables the second retention feature 5 to be pushed over the locking element 63. After the fastening frame 4 with the second retention feature 5 has first been detachably placed over the locking element 63, the fixing element 61 is locked by a pressing movement D, as can be seen in FIG. 2.

FIG. 3 shows an alternative embodiment of the connector. The connector is connected to a mating connector. The connector is designed with a connector housing 1 and a fastener 6 arranged in the first retention feature 2. A fastener 6 as previously described and shown in FIGS. 1 and 2 is inserted into the first retention feature 2. The mating connector and the mating connector housing 1′ have an alternative, second fastener 6′ in their first retention feature 2′. The second fastener 6′ has a fixing element 61 on its fastener body 60′ pointing in the plugging direction S′ of the mating connector. It can be seen that a fixing element 61 is arranged at the end of the second fastener 6′ when viewed in the plugging direction S′. In the shown, plugged state of the connector and mating connector, the fixing element 61 is engaged with the fastener body 60. In this way, the contact insert 3 and its fastening frame 4 of the connector housing 1 are securely held during the plugged-in state with the mating connector housing 1′ and the corresponding components. During a detachment process of the connector housing 1 and the mating connector housing 1′, the fixing element 61 is ideally removed from the fastener body 60 after overcoming the plugging forces or tensile forces of the contact elements arranged in the contact inserts 3 and 3′, so that the contact inserts 3 and 3′ are not jointly detached from the connector housing 1 or the mating connector housing 1′.

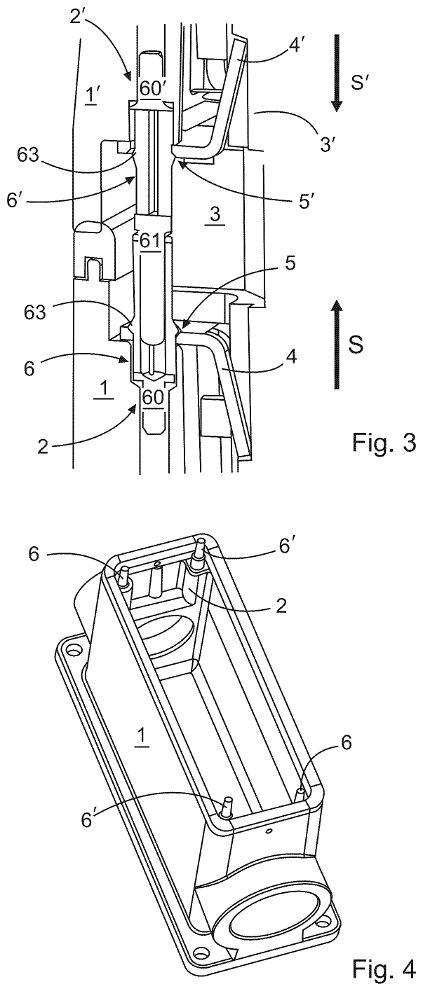

FIG. 4 shows a clever embodiment in which a connector housing 1, designed as an add-on housing, accommodates a first fastener 6 and a second fastener 6′ in each of the first retention feature 2 in a circumferentially alternating manner. The arrangement shown allows a particularly advantageous fastening of the contact inserts 3 to be used, or of the fastening frames 4 located thereon. Alternative arrangements of the fasteners 6 and 6′ are conceivable for coding purposes.

Even though various aspects or features of the invention are shown in combination in the figures, it is clear to those skilled in the art—unless otherwise stated—that the combinations shown and discussed are not the only possible ones. In particular, corresponding units or feature complexes from different embodiments can be exchanged with one another.

### LIST OF REFERENCE SIGNS

1 connector housing
2 first retention feature
3 contact insert
4 fastening frame
5 second retention feature
6 fastener
60 fastener body
61 fixing element
62 release element
63 locking element
64 securing element
65 securing feature
S plug-in direction
D pressing movement

What is claimed is:

1. An electrical connector, comprising:
a connector housing (1) with a cable feedthrough opening and a connection opening;
a first retention feature (2); and
a contact insert (3),
wherein the contact insert (3) accommodates at least one contact element and/or at least one connector module and/or a half connector module, and
wherein the contact insert (3) has a fastening frame (4) which has a second retention feature (5),
wherein the second retention feature (5) corresponds to the first retention feature (2),
wherein a fastener (6) interacts with the first retention feature (2) and the second retention feature (5),
wherein the fastening frame (4) is held in the connector housing (1) by the fastener (6), and
wherein the fastener (6) has
a fastener body (60),
a fixing element (61), and
a locking element (63).

2. The electrical connector according to claim 1,
wherein the fastener body (60) is connected to the first retention feature (2).

3. The electrical connector according to claim 1
wherein the locking element (63) is connected to the second retention feature (5).

4. The electrical connector according to claim 1,
wherein the locking element (63) is formed as a circumferential bulge which has a larger outer diameter than an inner diameter of the second retention feature (5).

5. The electrical connector according to claim 1,
wherein the locking element (63) is designed as a locking hook arranged on the fastener body (60), which holds the second retention feature (5) in a connected state in the connector housing (1).

6. The electrical connector according to claim 1,
wherein the contact insert (3) with the fastening frame (4) and the second retention feature (5) arranged thereon is configured to be pushed over the locking element (63) of the fastener (6),
wherein the locking element (63) is configured to elastically deflect into an interior of the fastener body (60).

7. The electrical connector according to claim 1,
wherein the fixing element (61) is inserted into the fastener body (60) counter to an insertion direction(S).

8. The electrical connector according to claim 1
wherein the connector housing (1) accommodates at least a first fastener (6′) and at least a second fastener (6″),
wherein the first fastener (6′) is designed as a socket element and the second fastener (6″) is designed as a pin element.

9. The electrical connector according to claim 8
wherein a second fixing element (61) is arranged on the second fastener (6″), and
wherein the second fixing element (61) is brought into engagement with the first fastener (6′) in a plugged-in state of the connector housing (1) with a mating connector housing (1′).

10. A method for connecting a contact insert (3) to a connector housing (1),
wherein the connector housing (1) has at least one first retention feature (2),
wherein the contact insert (3) has at least one second retention feature (5),
wherein the first retention feature (2) corresponds to the second retention feature (5),
wherein a fastener (6) is used to connect the contact insert (3) to the connector housing (1), and
wherein the fastener (6) has a fastener body (60), a fixing element (61), and a locking element (63).

11. The method according to claim 10,
wherein the fastener body (60) is essentially designed as a hollow pin which has elongated through openings at which the locking element is arranged so as to be elastically displaceable inwards.

12. The method according to claim 11,
wherein the fixing element (61) is inserted into the fastener body (60) and blocks the elastic displacement of the locking element (63).

13. The method according to claim 10,
wherein the connector (1) accommodates at least a first fastener (6′) and a second fastener (6″),
wherein the second fastener (6″) has a second fixing element (61), which in a plugged-in state of the connector housing (1) with a mating connector housing (1′) interacts with the fastener body (60) of the first fastener (6′).

14. The method according to claim 13,
wherein the first fastener (6′) and the second fastener (6″) are used as coding.
